(19) United States
(12) Patent Application Publication
(10) Pub. No.: US 2011/0168608 A1
(43) Pub. Date: Jul. 14, 2011

(54) WATER TREATMENT APPARATUS

(75) Inventor: Philip Gaffey, Rossendale (GB)

(73) Assignee: GAFFEY TECHNICAL SERVICES LIMITED, Rossendale (GB)

(21) Appl. No.: 12/742,122

(22) PCT Filed: Oct. 15, 2008
(86) PCT No.: PCT/GB2008/003481

§ 371 Date: Feb. 22, 2011

(30) Foreign Application Priority Data
Nov. 13, 2007 (GB) 0722229.2

(51) Int. Cl. C02F 1/68; B01D 35/153; B01D 35/157; B01D 35/147

(52) U.S. Cl. 210/86; 210/205; 210/97; 210/123; 210/136; 210/127; 210/90; 210/95; 210/137; 210/130

(57) ABSTRACT

A water treatment apparatus having a vessel defining a chamber adapted to contain a water treatment chemical over which a dosing liquid can flow from an inlet to form a dosing reservoir at the bottom of the vessel. A supply of dosing liquid is connected to the inlet. The interior of the vessel communicates with a conduit along which an entraining pressurized flow of water can be fed for treatment and via an opening in the conduit that is connected to a bottom outlet of the vessel. A venturi is located in the conduit adjacent the opening so that the velocity of the pressurized water is increased as it passes over the opening and entrains a dosing stream from the dosing reservoir into the pressurized flow. The venturi also applies suction to the interior of the vessel, which draws dosing liquid into the vessel from the supply.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a water treatment apparatus and, in particular, to a chemical dosing apparatus for use, primarily but not exclusively, in the sanitization of swimming pools and other commercial and industrial water-related processes.

2. Description of Related Art Including Information Disclosed Under 37 CFR 1.97 and 37 CFR 1.98.

Conventionally, chlorine in the form of a calcium hypochlorite solution is added to water as a method of water purification to make it fit for consumption as drinking water and also as a means of sterilizing the water in swimming pools. A chlorine solution may also be used in a disinfection stage in sewage treatment.

One method of chlorinating water is by using an erosion feeder. In an erosion feeder water is passed over solid, compressed calcium hypochlorite, which is slowly dissolved by the water and gradually eroded away. Such feeders may form a part of a swimming pool filtration system. In these systems, water under pressure is pumped into the feeder to dissolve the chlorine tablets or sticks which it contains. The flow and amount of chlorine introduced into the water is regulated by a flow control arrangement. However, these systems can be dangerous as the chlorine feeder is pressurized by the water. If a breach in the pressure vessel occurs, for example as a result of a fault or if an operative inadvertently loosens the lid of the feeder, pressurized chlorine gas, which is poisonous, can escape from feeder.

One object of the present invention is to provide a water treatment apparatus that overcomes the aforementioned disadvantage and is simple yet safe to use.

### BRIEF SUMMARY OF THE INVENTION

According to the present invention there is provided a water treatment apparatus comprising a vessel defining a chamber adapted to contain a water treatment chemical over which a dosing liquid can flow from an inlet to form a dosing reservoir at the bottom of the vessel; a supply of dosing liquid connected to the inlet of the vessel; a conduit along which an entraining pressurized flow of water can be fed for treatment and with which the interior of the vessel communicates via an opening in the conduit connected to an outlet from the dosing reservoir; and a venturi located in the conduit adjacent the opening so that the velocity of the pressurized water is increased as it passes over the opening entraining a dosing stream from the dosing reservoir into the pressurized flow, the venturi applying suction to the interior of the vessel which draws said dosing liquid into the vessel from the supply.

Preferably, the vessel comprises a safety valve that is adapted to open if the upper level of the dosing reservoir reaches a predetermined level in the vessel. Advantageously, the safety valve comprises a mechanical air float valve that opens to communicate the interior of the vessel with atmospheric pressure when the upper level of the dosing reservoir reaches said predetermined level.

The provision of the safety valve means that the level of the dosing reservoir can never rise to a level where it risks submerging the treatment chemical in the dosing liquid, which would lead to a high concentration of chemical solution being present within the vessel that could jeopardize the safety of an operator or cause excessive dosing of the water to occur. Operation of the safety valve equalizes the pressure inside the vessel to atmospheric pressure, which will immediately stop the flow of dosing liquid into the vessel from the supply.

Preferably also, a non-return valve is located between the outlet from the dosing reservoir and the opening in the conduit to prevent any liquid flow from the conduit into the vessel. Such a flow would prevent operation of the treatment apparatus as well as causing the possible contamination and dilution of the dosing stream.

Preferably also, the supply of dosing liquid comprises a supply chamber adapted to provide a reservoir of dosing liquid to feed the dosing liquid supply. Having a separate supply of dosing liquid to that of the pressurized flow of water for treatment means that the supply comprising the dosing liquid can be pre-treated as may be appropriate, for example to remove excess alkalinity, which could lead to scaling occurring within the vessel that would compromise its effective operation.

Other preferred but non-essential features of the invention are described in the dependent claims.

### BRIEF DESCRIPTION OF THE SEVERAL VIEWS OF THE DRAWINGS

An example of the present invention will now be described by way of example with reference to the accompanying drawings in which;

FIG. 1 is a schematic view showing the general arrangement of a water treatment apparatus according to the present invention;

FIG. 2 is a perspective view of an embodiment of water treatment apparatus produced in accordance with the diagram shown in FIG. 1;

FIG. 3 is a plan view of the interior of a vessel of the apparatus shown in FIG. 2; and

FIG. 4 is a schematic view showing a modified arrangement of water treatment apparatus.

### DETAILED DESCRIPTION OF THE INVENTION

With reference to the drawings, a water treatment apparatus 1 comprises a vessel 2 that defines an erosion chamber 3 in which can be located a water treatment chemical 4. A dosing liquid is arranged to flow into the erosion chamber 3 from a supply 5 via an inlet 6 that distributes the liquid over its contents. Typically, the water treatment chemical 4 contained within the chamber 3 will comprise blocks of calcium hypochlorite in tablet or stick form and the dosing liquid will comprise potable water in order that a chlorine solution is created on contact between them. This dosing liquid then exits the chamber 3 via an erosion plate 7 to form a reservoir 8 at the bottom of the vessel 2. The erosion plate 7 comprises a perforated plate through which the dosing liquid can pass but which retains within the erosion chamber all solid blocks 4 greater than a predetermined size. This is to prevent all but very small pieces of the blocks 4 breaking off and falling into the reservoir 8, which would adversely affect the concentration of the dosing stream. Water to be treated is supplied to the apparatus 1 via a conduit 9 to which the reservoir 8 in the interior of the vessel 2 is connected via an opening 10 in the conduit that is connected to an outlet 11 from the reservoir 8 at the bottom of the vessel 2. A venturi 12 is located in the conduit 9 adjacent the opening 10 so that the velocity of the water passing along the conduit 9 is increased as it passes over the opening 10 and entrains a dosing stream from the reservoir 8 into the flow. As the dosing stream enters the venturi 12 it is homogenized with the water flow through the venturi 12 to produce a ‘sanitized’ water flow for use as desired, for example for feeding into a swimming pool. As the venturi 12 operates, it also applies suction to the interior of the vessel 2 which, as a consequence, draws more dosing liquid into the vessel 2 from the supply 5.

The various features of this apparatus will now be described in more detail.

The water to be treated must be supplied to the conduit 9 as a motive pressurized water flow under pressure. This is necessary because the water flow must be of sufficient flow and pressure to develop an adequate suction or negative pressure within the vessel 2 in order that dosing liquid is drawn into it from the supply 5. An appropriate flow can be supplied by external means, for example as a pressurized water supply from a swimming pool circulation system, or be boosted via an auxiliary booster pump 13. The flow of water through the conduit 9 and thereby the degree of suction applied to interior of the vessel 2 is controlled by a regulating valve 14 which is located in a by-pass stream 15 that runs in parallel to the conduit 9. Pressure gauges 16 are located in the conduit 9 both upstream and downstream of the venturi 12 in order that the flow of pressurized water through the venturi 12 can be monitored. By adjusting the regulating valve 14, the water flow through the by-pass stream 15 is controlled this thereby controls the flow through the venturi 12, which has a direct effect on the degree of suction produced. Any change in the suction also has a direct effect on the rate of flow of the dosing liquid into the vessel 2 from the supply 5. A non-return valve 17 is located between the outlet 11 from the dosing reservoir 8 and the opening 10 in the conduit to prevent flow of motive water from the venturi 12 into the vessel 2 which would prevent adequate treatment of the water within the conduit 9 and could contaminate and the reduce the concentration of the dosing stream.

The by-pass regulating valve 14 can be controlled manually, by using a hand-operated control valve, or automatically. Automatic control can be achieved by using an electric or pneumatic diaphragm or solenoid pinch valve providing open and closed cyclic control or by using an electric or pneumatic ball, globe, needle or pinch valve providing open and closed cyclic control with fine adjustment via a control signal.

The vessel 2 comprises a tubular vessel which is split into two portions by the erosion plate 7. Below the erosion plate 7 the interior of the vessel is adapted to hold the reservoir 8 of dosing liquid. Above the erosion plate 7 is the erosion chamber 3 for holding the chemical blocks 4. The erosion chamber 3 is accessed for maintenance and to replenish the blocks 4 of treatment chemical via a lid 18 that has an airtight seal 19 around its periphery so that air cannot be drawn into the vessel 2 from the exterior. A sufficient stock quantity of chemical blocks 4 is necessary within the erosion chamber 3 for an effective production of dosing solution. The chamber 3 is therefore configured to be filled to just below the lid 18 to provide a gravity stock feed of blocks to the level of the chamber 3 below the inlet 6. The inlet 6 is located a predetermined distance above the erosion plate 7 and is connected to nozzles 20 which are adapted to control the distribution of the dosing liquid over the chemical blocks 4. To this end, the nozzles 20 preferably protrude into the chamber 3 and an orifice in each nozzle 20 is adapted to be of a predetermined size dependent on the internal cross-sectional area of the erosion chamber 3. While a single nozzle 20 could be used, in order to prevent the dosing liquid creating a preferential pathway through the chemical blocks 4, preferably three nozzles 20 arranged at 120° around the circumference of the vessel 2 are used. The distance of the nozzles 20 above the erosion plate 7 together with the effective distribution of the dosing liquid entering the erosion chamber 3 controls the strength of the dosing solution created within the erosion chamber 3 as the dosing liquid contacts and flows past the chemical blocks 4.

In some embodiments, the lid 18 can be made transparent or incorporate a window so that the state of the chemical blocks 4 can be seen and can be replenished when required. This means that the lid 18 does not have to be constantly removed to check on the condition of the blocks 4, which would interrupt operation of the apparatus.

It will be appreciated that when the venturi 12 creates suction within the vessel 2, a motive dosing stream is created between the supply chamber 5 and venturi 12. Normally, the dosing stream exiting the vessel 2 from the reservoir 8 balances the supply of dosing liquid entering the vessel 2 via the inlet 6. However, it is possible that if an excessive degree of suction is applied to the vessel 2 for a prolonged period of time preceding a sudden loss of motive water flow through the venturi 12, the negative pressure still present in the vessel 2 will continue to create a flow of dosing liquid into the vessel 2 from the supply 5. Hence, the level of the reservoir 8 will rise and, if not interrupted, could continue to rise above the level of the erosion plate 7 causing the chemical blocks 4 to become submerged in the dosing solution. This is a potential hazard as a high concentration of chemical solution will be present within the vessel 2 and could jeopardize the safety of an operator when removing the lid 18. Such a high concentration of dosing solution could also cause excessive dosing of the water to occur when the apparatus 1 returns to normal operation. In order to prevent this potential hazard from occurring, a safety valve 21 is located within the vessel 2 that is adapted to open if the upper level of the dosing reservoir reaches a predetermined level in the vessel. In the present embodiment the safety valve 21 comprises a mechanical air float valve that opens to communicate the interior of the vessel 2 with atmospheric pressure when the upper level of the dosing reservoir reaches a level at which the float 22 of the valve 21 is located within the vessel 2. This level is well below the level of the erosion plate 7. It will be appreciated that once the valve 21 is opened, the pressure inside the vessel 2 is equalized to atmospheric pressure which immediately stops the flow of dosing liquid into the vessel 2 from the supply 5.

In a water treatment apparatus for use in the treatment of swimming pools or other water sanitizing purposes, the dosing liquid is water which should be of potable standard. This is to ensure that the dosing solution formed within the erosion chamber 3 is of an adequate concentration. If a potable water supply is not available then alternative water supply sources may be used, for example filtered pool water or a clean water process stream. It will be appreciated, however, that in other applications of the treatment apparatus, the dosing liquid may comprise a different liquid which can be sourced appropriately.

An advantage of the invention is that it can use a separate dosing liquid supply from that of the water supply forming motive water flow. This enables the dosing liquid supply to be preconditioned. If water comprises the dosing liquid, then in applications where the supply water and/or motive water flow has a total alkalinity content above 40 mg/l, typically owing to the presence of calcium carbonate then scaling will occur in the vessel 2, both in the erosion chamber 3 and the reservoir 8, and also on the erosion plate 7. Preconditioning of the supply water through a process of dealkalisation can reduce and maintain levels of total alkalinity below 40 mg/l, thereby eliminating the scaling and thereby enable the apparatus to operate effectively in geographically hard water areas. This is a considerable advantage over conventional water treatment apparatus that do not use an independent water supply for the dosing chemical erosion process.

The source 5 of dosing liquid comprises a supply chamber 23 that is supplied with dosing liquid from a source 24 at a predetermined minimum supply pressure, typically of 0.1 Bar, which can be monitored by a pressure gauge 25. Preferably, there is an air gap between the source 24 and the liquid level in the chamber 23, which is also arranged with a weir overflow (not shown). This prevents backflow of liquid from the supply chamber 23 into the source 24, which typically would be a mains water supply, and is therefore a safeguard against mains contamination. Such an arrangement complies with the standards of the U.K. water authorities. The supply of dosing liquid to the chamber 23 is regulated by a float valve 26 which maintains a consistent level of dosing liquid in the chamber 23. It is important that the chamber 23 provides an adequate reservoir of dosing liquid to feed the vessel 2 in order to ensure that there are no air gaps within the supply and to prevent any danger of backflow. The flow of the dosing liquid from the chamber 23 to the vessel 2 is controlled by a control valve 27, which can be regulated by manual operation or by an automated valve operation. In manual operation the valve 27 will comprise a manual, hand-operated control valve and the rate of flow to the vessel 2 is monitored by using a rotameter or flow meter 28. If the valve 27 is automatically controlled, the flow of dosing liquid to the vessel 2 can be regulated by any of the following optional control valve devices, namely an electric or pneumatic diaphragm or solenoid pinch valve providing open and closed cyclic control, or an electric or pneumatic ball, globe or needle valve for open and closed cyclic control or by fine adjustment via a control signal input to the valve.

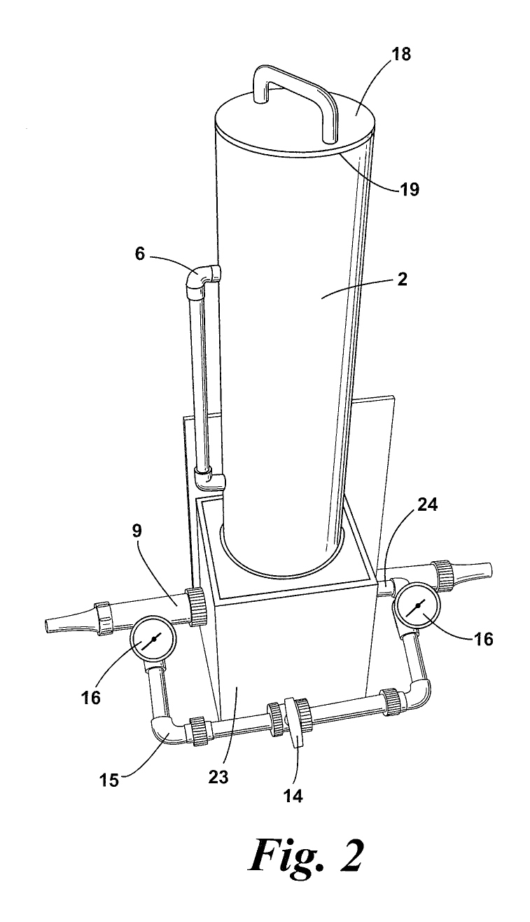

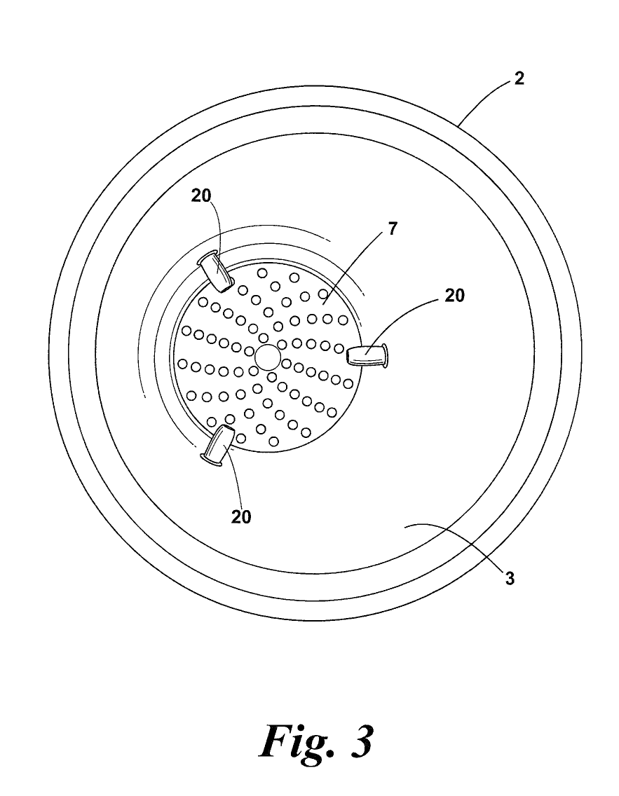

With reference to FIGS. 2 and 3, in an embodiment of the apparatus suitable for use in the treatment of swimming pools and the like, the supply chamber 23 can be located beneath the vessel 2 in order that the apparatus 1 has a compact configuration suitable for use in a confined space.

One advantage of the apparatus is that it is self-regulating as it pulls dosing liquid into the vessel 2 at the same rate as the dosing stream leaves the reservoir 8. Another advantage of the apparatus is that chlorination of the dosing liquid takes place under negative pressure conditions. This means that should an operator try to remove the lid 18 during operation, the flow of dosing liquid into the vessel 2 will immediately cease. Hence, the risk of water jet or spray exiting the vessel 2 via feeder lid area as a result of this action is removed. Also, there can be no build-up of dangerous fumes within the vessel 2 which could escape if the integrity of the vessel 2 is compromised, which is a danger in conventional apparatus. However, the dosing stream to the venturi 12 will continue, even when the lid is removed, until the reservoir 8 is used. This means that the lid 18 can be removed to replenish the chemical supplies in the erosion chamber 3 without interrupting the water treatment.

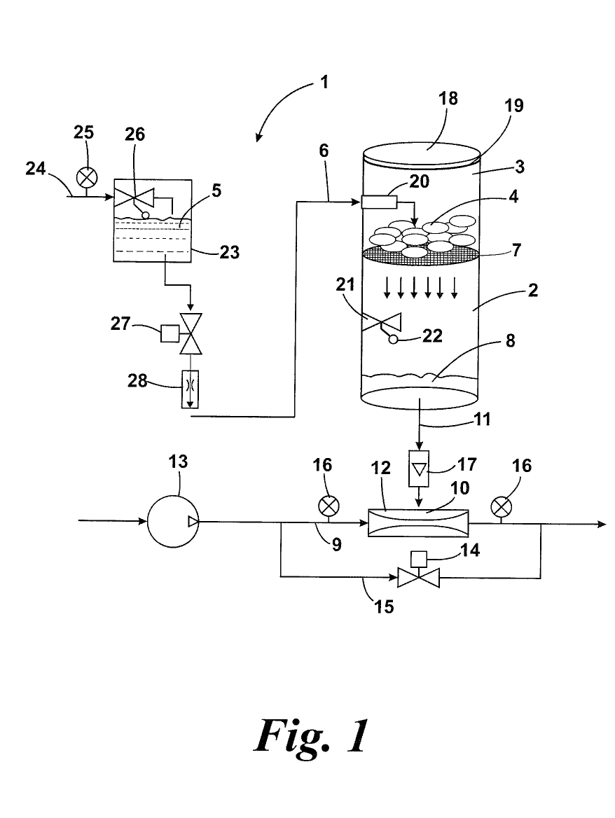

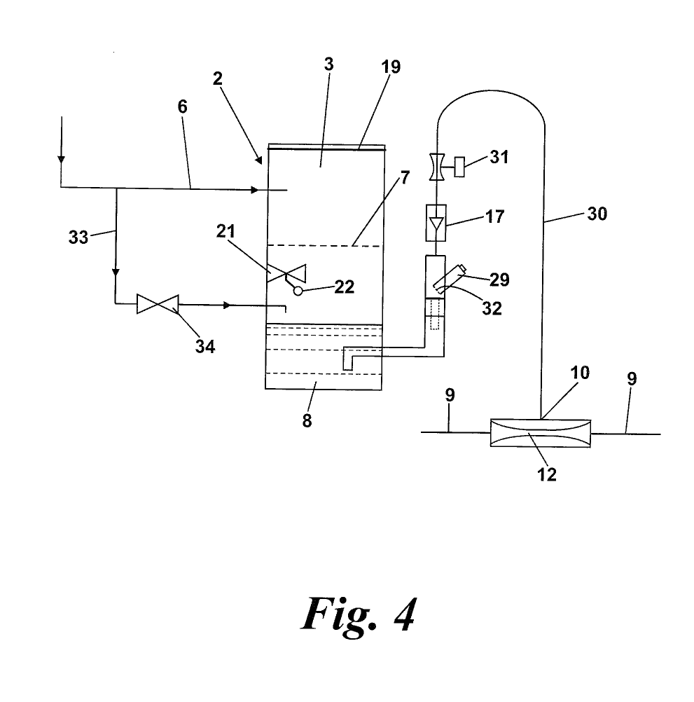

In a modified apparatus, as shown in FIG. 4, the outlet 11 from the reservoir 8 at the bottom of the vessel 2 is connected to a strainer 29, which is located upstream of the non-return valve 17. The outlet of the valve 17 is then connected to a flexible tube 30, for example a silicone tube, which is connected to the opening 10 in the conduit 9. A solenoid-operated pinch valve 31 is provided downstream of the valve 17 to open or close off the tube 30. Operation of the pinch valve 31 is linked to the operation of the control valve 27 so that both valves 27 and 31 open and close simultaneously. It will be appreciated that in this modification the valve 27 is automatically controlled. Other parts of the apparatus are as described above with reference to FIGS. 1 to 3.

This modified apparatus has several advantages. First, when the control valve 27 is closed, the pinch valve 31 also closes at the same time so that the reduced pressure within the vessel 2 created by the venturi 12 is maintained despite the dosing stream being closed off. This means that when the valves 27 and 31 are opened, the dosing stream is immediately reinstated as the pressure within the vessel 2 does not have to be again reduced by operation of the venturi 12. In addition, the dosing stream is immediately cut-off by the valve 31 in response to the control signal. This provides a highly accurate response time for cutting off and for reinstatement of the dosing stream that can be valuable in some applications of the apparatus. Second, the strainer 29, which could be provided regardless of the use or otherwise of the pinch valve 31, prevents small pieces of dosing chemical 4 that have not dissolved in the dosing stream from clogging the inlet 10 or the tube 30. In addition, a mesh 32 within the strainer 29 acts as a secondary dissolving/contact chamber for the chemical 4. Preferably, for this purpose the strainer 29 comprises a ‘Y’ strainer and the mesh 32 has a mesh size between 1.5 mm and 2.5 mm inclusive. Finally, the use of the pinch valve 31 in combination with the flexible tube 30 means that the dosing stream is always completely cut-off when the valve 31 is closed because the valve 31 will close the tube 30 even if it is partially clogged by chemical debris because it will pinch against it. This is preferable to other forms of valve as the latter may become clogged by such debris so that closure is only partial.

It will be appreciated that as the conduits along which the dosing stream flows can become clogged by small pieces of dosing chemical, it is important that during maintenance of the apparatus these conduits are flushed out to remove it. To this end, the apparatus preferably incorporates a branch 33 off the supply to the inlet 6 that leads directly into the dosing reservoir 8. This branch 33 is closed off during normal operation of the apparatus by a valve 34 but during maintenance of the apparatus the valve 34 can be opened to provide a flushing flow of liquid through the reservoir 8, out of the outlet 11, through the strainer 29 and the valves 17 and 31 and through the inlet 10 to flush away any solid debris that may have accumulated.

It will be appreciated that in use the water treatment apparatus of the invention has been primarily configured to provide a safe and convenient method of sanitizing domestic, commercial and municipal swimming pools and other commercial and industrial water-related processes. Typically, the water is treated with a dilute chlorine solution, namely calcium hypochlorite w/w=0.25% to 1.5% strength, by the use of conventional dry tablet or pellet calcium hypochlorite. Output of the dosing chlorine solution is regulated by manual or automatic valve adjustment in a flow range typically but not limited to between 0 to 250 lph.

It will also be appreciated, however, that the apparatus could be readily adapted for the treatment or dosing of water or other liquids in other commercial and industrial processes and the use of the term ‘water’ herein and in the claims should be interpreted appropriately to cover other liquids suitable for dosing or treatment in a similar fashion.

1. A water treatment apparatus comprising
a vessel defining a chamber adapted to contain a water treatment chemical over which a dosing liquid can flow from an inlet to form a dosing reservoir at the bottom of the vessel;
a supply of dosing liquid connected to the inlet of the vessel;
a conduit along which an entraining pressurized flow of water can be fed for treatment and with which the interior of the vessel communicates via an opening in the conduit connected to an outlet from the dosing reservoir; and
a venturi located in the conduit adjacent the opening so that the velocity of the pressurized water is increased as it passes over the opening entraining a dosing stream from the dosing reservoir into the pressurized flow, the venturi applying suction to the interior of the vessel which draws said dosing liquid into the vessel from the supply.

2. An apparatus as claimed in claim 1, wherein the vessel comprises a safety valve that is adapted to open if the upper level of the dosing reservoir reaches a predetermined level in the vessel.

3. An apparatus as claimed in claim 2, wherein the safety valve comprises a mechanical air float valve that opens to communicate the interior of the vessel with atmospheric pressure when the upper level of the dosing reservoir reaches said predetermined level.

4. An apparatus as claimed in claim 1, wherein a non-return valve is located between the outlet from the dosing reservoir and the opening in the conduit to prevent any liquid flow from the conduit into the vessel.

5. An apparatus as claimed in claim 4, wherein a strainer is located between the outlet from the dosing reservoir and the non-return valve.

6. An apparatus as claimed in claim 5, wherein a control valve is provided to control the supply of dosing liquid to the inlet of the vessel.

7. An apparatus as claimed in claim 6, wherein a valve is located between the non-return valve and the opening in the conduit, the operation of said valve is linked to the operation of the control valve.

8. An apparatus as claimed in claim 7, wherein the valve located between the non-return valve and the opening in the conduit is a pinch valve which operates to close a flexible tube carrying the dosing stream from the non-return valve to the opening in the conduit.

9. An apparatus as claimed in claim 1, wherein a flow meter is provided to allow the rate of flow of the dosing liquid to the inlet of the vessel to be monitored.

10. An apparatus as claimed in claim 1, wherein the supply of dosing liquid comprises a supply chamber adapted to provide a reservoir of dosing liquid to feed the dosing liquid supply.

11. An apparatus as claimed in claim 10, wherein the supply chamber comprises a float valve to regulate and to maintain a consistent level of dosing liquid in the supply chamber.

12. An apparatus as claimed in claim 10, wherein a pressure gauge is provided to allow the pressure of a source of dosing liquid to the supply chamber to be monitored.

13. An apparatus as claimed in claim 1, wherein chamber within the vessel comprises an erosion plate defining an erosion chamber adapted to contain chemical blocks through which the dosing liquid can percolate and exit, after passing through the erosion plate, to form the dosing reservoir.

14. An apparatus as claimed in claim 13, wherein the inlet is located a predetermined distance above the erosion plate.

15. An apparatus as claimed in claim 13, wherein the inlet comprises one or more nozzles adapted to control the distribution of the dosing liquid over the chemical tablets.

16. An apparatus as claimed in claim 15, wherein an orifice in each nozzle is of a predetermined size dependent on the internal cross-sectional area of the erosion chamber.

17. An apparatus as claimed in claim 13, wherein the vessel comprises a lid with an airtight seal that can be opened to gain access to the erosion chamber.

18. An apparatus as claimed in claim 17, wherein the lid is transparent or incorporates a window in order that the lid does not have to be removed to reveal the interior of the erosion chamber.

19. An apparatus as claimed in claim 1, wherein a regulating valve is provided to control the pressurized flow of water through the conduit and thereby control the degree of suction applied to interior of the vessel.

20. An apparatus as claimed in claim 19, wherein the regulating valve is located in a by-pass stream that runs in parallel to the conduit.

21. An apparatus as claimed in claim 1, wherein a pressure gauge is located in the conduit in order that the flow of pressurized water through the venturi can be monitored.

22. An apparatus as claimed in claim 21, wherein pressure gauges are located both upstream and downstream of the venturi.
